(19) United States
(12) Patent Application Publication
(10) Pub. No.: US 2009/0193072 A1
(43) Pub. Date: Jul. 30, 2009

(54) SHARED SOFTWARE MANAGEMENT METHOD AND APPARATUS

(75) Inventor: Soo-jung KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/169,117

(22) Filed: Jul. 8, 2008

(30) Foreign Application Priority Data
Jan. 24, 2008 (KR) 10-2008-0007578

(51) Int. Cl. G06F 15/16

(52) U.S. Cl. 709/203

(57) ABSTRACT

Provided is a shared software management method including: receiving a signal for requesting to delete a shared software used by a second device from one or more first device; and when the delete request signal is received, blocking the output from an interface for executing the shared software to be transmitted to a display of the first device that transmits the delete request signal. Accordingly, when there is a delete instruction from the user, the shared software looks deleted from a screen, so that a user environment can be improved. In addition, the shared software is deleted by a manager, so that the ill-considered deletion can be prevented. In addition, the shared software can be recovered instead of re-installing the software instructed to be deleted by the user's instruction, so that there are advantages in terms of managing the software shared by devices in the network.

### CROSS-REFERENCE TO RELATED PATENT APPLICATION

This application claims priority from Korean Patent Application No. 10-2008-0007578, filed on Jan. 24, 2008 in the Korean Intellectual Property Office, the disclosure of which is incorporated herein in its entirety by reference.

### BACKGROUND OF THE INVENTION

1. Field of the Invention

Methods and apparatuses consistent with the present invention relate to shared software management, and more particularly, to deleting software shared by devices connected through a network.

2. Description of the Related Art

Recently, due to content development, a number of software programs associated with various peripheral devices have been provided. In a case where the software programs are frequently used, there is no problem. However, in a case where a software program is not frequently used, if the software program occupies a large portion of a display of a device even when the software program is not needed, there is a problem in that a familiar user environment cannot be provided.

In addition, due to the development of networks, a number of devices are connected through a network. In an office environment, many people are provided with their own computer but do not have their own printer, copy machine, fax machine, or the like. Instead, a few devices are connected through a network and are shared by people. Since various people use only one or a few devices, many problems occur.

Particularly, when a user deletes a program for managing the shared device, recovery is impossible, and another user cannot use the program.

### SUMMARY OF THE INVENTION

The present invention provides a shared software management method and apparatus capable of making a shared software appear deleted from only a display screen so that the shared software is not actually deleted although a user deletes the shared software, and completely deleting or recovering the shared software by a person having an authority to manage the shared software, thereby effectively managing the shared software shared by devices.

According to one aspect of the present invention, there is provided a method of managing a shared software. The method includes receiving a delete request signal from at least one first device to delete a shared software used by a second device, and when the delete request signal is received, blocking the output from an interface for executing the shared software to be transmitted to a display of the at least one first device that transmits the delete request signal.

The method may further include when the delete request signal is received, making a determination whether to delete the shared software by comparing a frequency of using the shared software with a reference frequency, and selectively deleting the shared software according to the determination.

The operation of deleting the shared software may include deleting the shared software when the frequency of using the shared software is less than the reference frequency according to the determination.

The method may further include transmitting a delete confirm request to the first device that transmits the delete request signal, when the frequency of using is equal to or more than the reference frequency according to the result of the determination.

The method may further include selectively recovering the shared software when the first device receives the delete confirm request.

The method may further include deleting the shared software when the delete request signals are received from all of the at least one first device.

The method may further include checking a frequency of using the shared software by each of the at least one first device, and deleting the software when the frequency of using the shared software is less than a reference frequency.

According to another aspect of the present invention, there is provided a method of managing a shared software. The method includes at least one first device receiving a delete request signal to delete a shared software used by a second device, and the at least one first device which receives the delete request signal blocking the output from an interface for executing the shared software.

The method may further include the first device which receives the delete request signal transmitting the delete request signal to a shared software management device.

According to another aspect of the present invention, there is provided an apparatus for managing a shared software. The apparatus includes a communication unit receiving a delete request signal to delete a shared software used by a second device from at least one first device, and a control unit blocking the output from an interface for executing the shared software to be transmitted to a display of the at least one first device that transmits the delete request signal, when the delete request signal is received.

According to another aspect of the present invention, there is provided an apparatus for managing a shared software. The apparatus includes a communication unit receiving a signal for requesting to delete a shared software used by a predetermined device, and a control unit blocking the output from an interface for executing the shared software when the delete request signal is received.

The second device may be, but is not limited to, a copy machine, a printer, and a multi-function printer.

### BRIEF DESCRIPTION OF THE DRAWINGS

The above and other aspects of the present invention will be more apparent by describing in detail exemplary embodiments thereof with reference to the attached drawings in which:

FIG. 1 is a block diagram illustrating a shared software management system according to an exemplary embodiment of the present invention;

FIG. 2 is a view illustrating an example of a management screen for managing the shared software in the software management unit;

FIG. 3 is a flowchart of a shared software management method according to an exemplary embodiment of the present invention;

FIG. 4 is a flowchart of a shared software management method according to another embodiment of the present invention; and

FIG. 5 is a flowchart of a shared software management method according to another embodiment of the present invention.

### DETAILED DESCRIPTION OF THE EXEMPLARY EMBODIMENTS

Hereinafter, exemplary embodiments of the present invention will be described in detail with reference to the attached drawings.

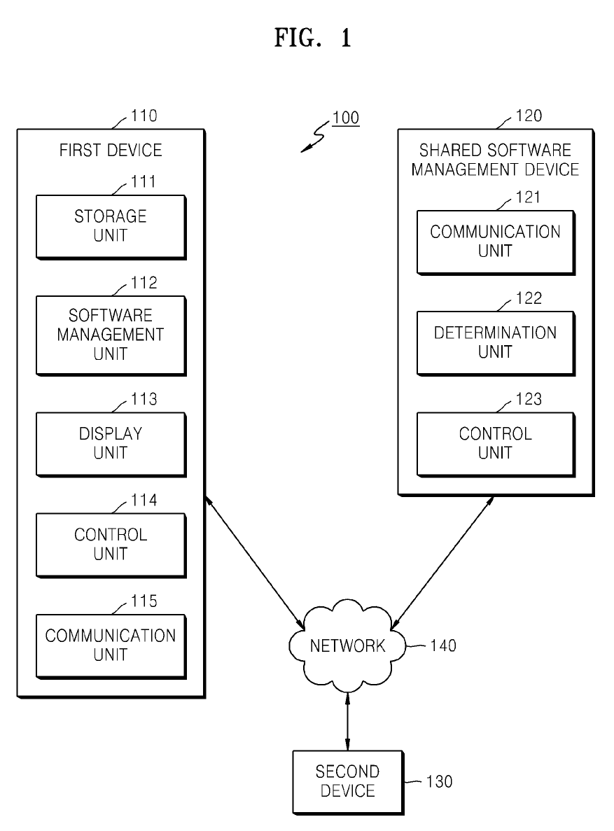

FIG. 1 is a block diagram illustrating a shared software management system according to an exemplary embodiment of the present invention.

Referring to FIG. 1, the shared software management system 100 includes at least one first device 110, a shared software management device 120, a second device 130, and a network 140 connecting the devices. The at least one first device 110 includes a storage unit 111, a software management unit 112, a display unit 113, a control unit 114, and a communication unit 115. The shared software management device 120 includes a communication unit 121, a determination unit 122, and a control unit 123. According to an exemplary embodiment of the present invention, the shared software management device 120 may be a server. Otherwise, the device which manages the shared software may be one of the at least one first device that is granted with a software management authority or the second device using the shared software.

The first device 110 shares software used by the second device 130. For example, when the second device 130 is a multi-function printer, the shared software refers to a number of application software programs including a driver associated with the multi-function printer. Exemplary embodiments of the application software programs may include software associated with a printer, software associated with a copy machine, software associated with a scanner, software associated with a fax, and firmware included in the multi-function printer. Here, when it is assumed that the first device 110 and the second device 130 may be computers, the shared software may be a number of software programs for managing or controlling the second device 130. Currently, due to a variety of associated technology and content, the number of associated application software programs for controlling a device has significantly increased. In order for a device to use the second device 130, the software used by the second device 130 has to be shared. In the above exemplary embodiment, the second device 130 is not limited to the multi-function printer but may be a device such as a printer, a scanner, a digital television, a mobile terminal, a computer, and the like, which can be connected through a network and can share the software used by the second device 130. The first device 110 may be a device such as a computer or a digital television which can operate the shared software.

The storage unit 111 of the first device 110 stores the shared software, and the software management unit 112 manages the shared software.

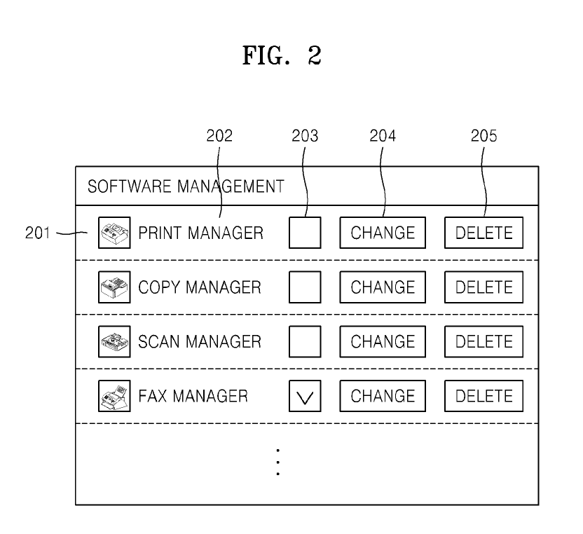

FIG. 2 is a view illustrating an example of a management screen for managing the shared software in the software management unit 112. In the software management screen, a list of all software programs in the first device 110 may be displayed, or a list of software programs associated with a particular device may be displayed. Referring to FIG. 2, a list of software programs associated with the multi-function printer is displayed. The software management screen includes icons 201 representing the software programs, names 202, select items 203, change items 204, and delete items 205. In FIG. 2, a fax manager that is a software program associated with the fax is selected. The management screen illustrated in FIG. 2 is only an exemplary embodiment and the management screen is not limited to the management screen illustrated in FIG. 2.

When a delete request signal is received, that is, a user selects the delete item 205 illustrated in FIG. 2, the control unit 114 of the first device 110 blocks the output from an interface for executing the shared software to be transmitted to the display unit 113 of the first device 110 that transmits the delete request signal. The interface for executing the shared software refers to particulars such as directories storing the shared software, files, a program menu for the execution, and the like which may be needed to execute the shared software and displayed on the display unit 1 13. The blocking of the output from the interface makes the corresponding shared software look deleted from the first device 110. Therefore, a user of the first device 110 cannot see anything associated with the shared software and cannot execute the shared software. This also means that the shared software is deleted from the management screen and cannot be seen. In an exemplary embodiment, it means that icons used to execute the shared software or character formats including an execution instruction are deleted. Therefore, from the user's point of view, the shared software is completely deleted from the first device 110. However, the software is still stored in the first device 110. According to an exemplary embodiment, the deleted software may be displayed in a deactivated state. The shared software management device 120 may block the output from the interface for executing the shared software to be transmitted to the display unit 130 of the first device 110.

The control unit 114 may selectively delete the shared software according to a delete confirm request signal received from the shared software management device 120. In this case, the corresponding shared software stored in the storage unit 111 is deleted from the first device 110, resulting in a complete deletion. In a case where the shared software is not to be deleted, the blocking may be canceled to recover the shared software.

The communication unit 115 of the first device 110 transmits a shared software delete request signal to the shared software management device 120 through the network 140.

The second device 130 refers to an object that can be controlled by the shared software. The second device 130 may be one of a copy machine, a printer, and a multi-function printer but not limited thereto. In terms of home networking, consumer electronics (CE) devices such as a digital television, a refrigerator, a washing machine, and the like are connected, and the CE devices may be controlled by a predetermined control device. Devices connected through the network may be the second device, the first device 110 that is to be the control device, or the shared software management device 120. In addition, any product that can download user contents may be applied.

The shared software management device 120 performs management on the shared software. The communication unit 121 receives a delete request signal to delete the shared software used by the second device from the at least one first device 110.

When the control unit 123 receives the delete request signal through the communication unit 121, the control unit 123 blocks the output from the interface for executing the shared software to be transmitted to the display unit 113 of the first device 110 that receives the delete request signal. As described above, the blocking of the output from the interface makes the corresponding shared software appear to be deleted from the first device 110. Therefore, the user of the first device 110 cannot see anything associated with the shared software and cannot execute the shared software. However, the software is still stored in the first device 110. In addition, the control unit 123 can delete the shared software.

When the determination unit 122 receives the delete request signal from the first device 110, the determination unit 122 compares a frequency of using the shared software by the user of the first device 110 with a reference frequency. A frequency of using software associated with the second device 130 by the first device 110 and the reference frequency may be stored in the shared software management device 120. The frequency of using may include the number of uses, a time in use, the day for the uses, and the like. The reference frequency may be set and stored by the determination unit 122 in advance according to each item included in the frequency of using. In addition, the determination unit 123 checks a frequency of using the shared software by each of the at least one first device 110 and determines whether to delete the shared software by comparing the frequency with the reference frequency. When the output from the interface for executing the shared software which is to be transmitted to a first device is blocked, the first device does not use the shared software, however, other first devices can use the shared software. However, when other first devices do not use the shared software, even if there is no delete request, the shared software can be deleted by checking a frequency of use.

When the control unit 123 receives a delete request signal from the at least one first device 110, the control unit 123 may selectively delete the shared software. The control unit 123 deletes the shared software when the frequency of use is less than the reference frequency according to a result of the determination by the determination unit 122. However, when the frequency of use is equal to or larger than the reference frequency, the control unit 123 transmits a delete confirm request signal for confirming whether to delete the shared software of the first device 110 that transmits the delete request signal, through the communication unit 121. When a delete approval request is received, the shared software may be deleted. In addition, the control unit 123 may delete the shared software when receiving the delete request signals from all of the first devices 110. In this case, the shared software may be automatically deleted, or a delete permission may be received from the first device 110.

The network 140 connects the first device 110, the shared software management device 120, and the second device 130 to each other. The network 140 may be, but is not limited to, a wired communication network, a wireless communication network, or a broadcasting network.

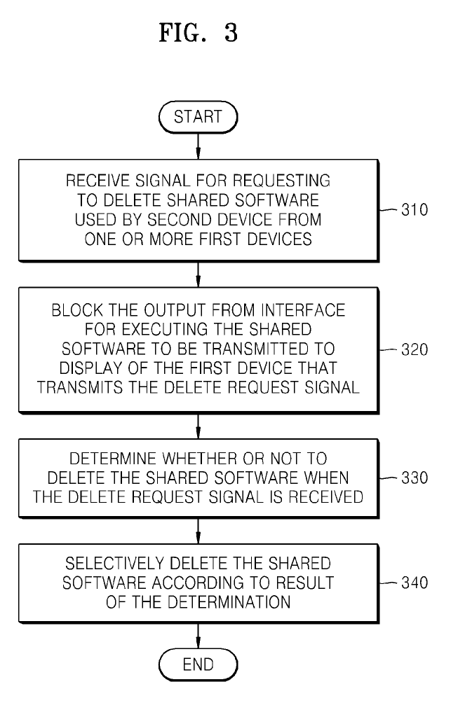

FIG. 3 is a flowchart of a shared software management method according to an exemplary embodiment of the present invention.

Referring to FIG. 3, in operation 310, when a user of a first device selects a delete item of a particular shared software on a software management screen (see FIG. 2), the first device transmits a delete request signal to the shared software management device (a server, another first device having a shared software management authority, or a second device), and the shared software management device receives the delete request signal. The shared software that is to be deleted is software for managing the second device. For example, when the second device is a multi-function printer, the shared software may be, but is not limited to, a printer control software, a picture file control software, a fax control software, or the like. Once the shared software controls or manages the second device and is shared by the first device, the shared software is not limited. Here, the second device is an object that can be controlled by the shared software and may be one of a copy machine, a printer, and a multi-function printer but not limited thereto.

In operation 320, the shared software management device blocks the output from an interface for executing the shared software to be transmitted to a display of the first device that transmits the delete request signal. The blocking of the output from the interface makes the corresponding shared software look deleted from the first device. Therefore, a user of the first device cannot see anything associated with the shared software and cannot execute the shared software. This also means that the shared software is deleted from the management screen and cannot be seen. For example, it means that icons used to execute the shared software or character formats including an execution instruction are deleted. Therefore, from the user's point of view, the shared software is completely deleted from the first device. However, the software is still stored in the first device. According to an exemplary embodiment, the deleted software may be displayed in a deactivated state.

In operation 330, when the shared software management device receives the delete request signal, it is determined whether to delete the shared software. In this case, a frequency of using the shared software by the user of the first device is compared with a reference frequency. The frequency of using the software associated with the second device by the first device and the reference frequency may be stored in the shared software management device. The frequency of using may include the number of uses, a time in use, the day for the uses, and the like. The reference frequency may be set and stored by the shared software management device in advance according to each item included in the frequency of using. In addition, the shared software management device checks a frequency of using the shared software by each of the at least one first device and determines whether or not to delete the shared software by comparing the frequency with the reference frequency. When the output from the interface for executing the shared software which is to be transmitted to a first device is blocked, the first device does not use the shared software, however, other first devices can use the shared software. However, when other first devices do not use the shared software, even if there is no delete request, the shared software can be deleted by checking the frequency of using.

In operation 340, the shared software is selectively deleted according to a result of the determination. Here, before deleting the shared software, whether to delete the shared software may be confirmed by the device that transmits the delete request signal.

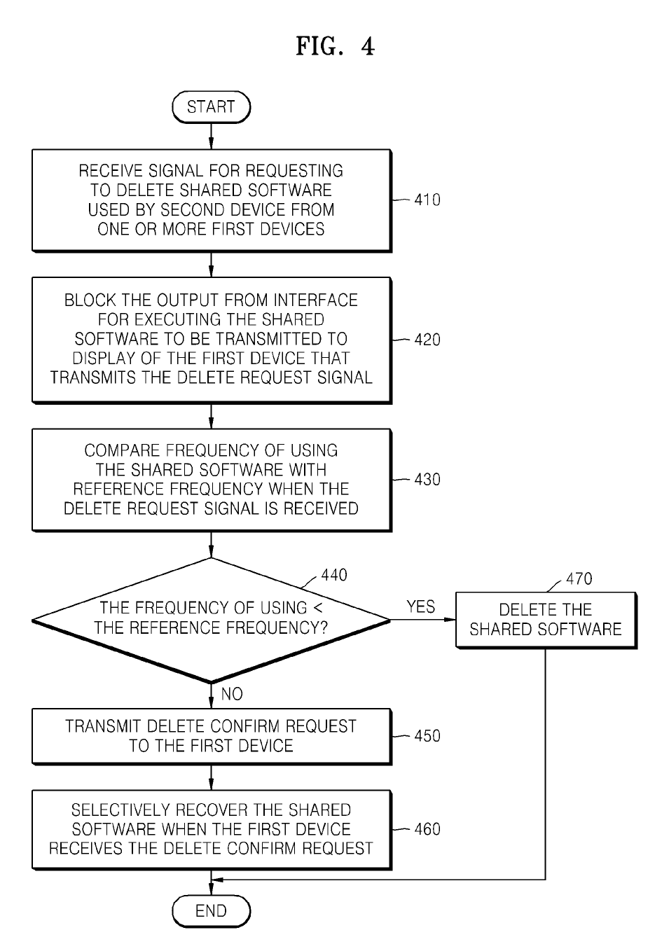

FIG. 4 is a flowchart of a shared software management method according to another exemplary embodiment of the present invention.

Operations 410 and 420 illustrated in FIG. 4 correspond to operations 310 and 320 illustrated in FIG. 3. Therefore, a description thereof is omitted.

When a deletion of a particular software is selected on a software management screen, the first device transmits a delete request signal to the shared software management device, and the shared software management device receives the delete request signal. The software to be deleted is the shared software used by the second device.

In operation 430, when the shared software management device receives the delete request signal, a frequency of using the shared software by the user of the first device that transmits the delete request signal and the reference frequency are checked. The frequency of using may include the number of uses, a time in use, the day for the uses, and the like. The reference frequency may be set in advance according to each item included in the frequency of using. Thereafter, the frequency of using the shared software is compared with the reference frequency on the basis of an item of the frequency of using. In addition, the shared software management device may check a frequency of using the shared software by each of the at least one first device and determine whether to delete the shared software by comparing the frequency of using with the reference frequency.

In operation 440, when the frequency of using is equal to or more than the reference frequency, in operation 450, a delete confirm request signal is transmitted to the first device that transmits the delete request signal. For example, when it is assumed that the number of uses is 200 times, a time in use is 155 hours, and the day for the uses is 96 days, while the reference frequency includes the number of uses set to 100 times, a time in use set to 100 hours or more, and the day for the uses set to 50 days, the delete confirm request signal that means a complete deletion of the software is transmitted to the device that transmits the delete confirm request signal.

In operation 460, when the first device that transmits a delete request receives the delete confirm request signal, the shared software may be completely deleted according to a selection of the user of the device. In a case where the shared software is not to be deleted, the shared software may be recovered. In this case, the blocking of the output to the display may be canceled so that the user can use the shared software.

In operation 470, when the frequency of using is less than the reference frequency, the shared software is completely deleted.

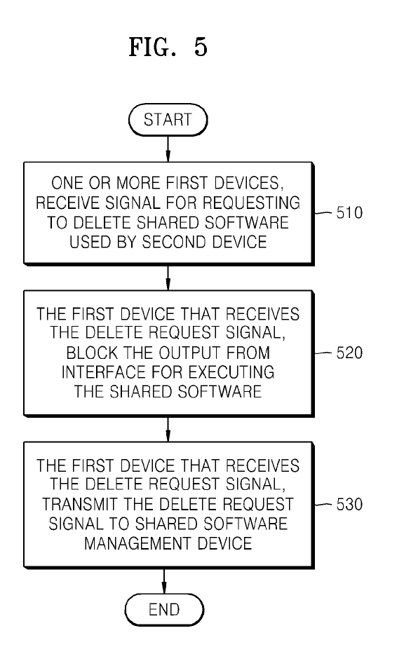

FIG. 5 is a flowchart of a shared software management method according to another embodiment of the present invention.

Referring to FIG. 5, in operation 510, the at least one first device receive a delete request signal to delete the shared software used by the second device. That is, the first device receives the delete request signal from a user of the shared software.

In operation 520, the first device that receives the delete request signal blocks the output from an interface for executing the shared software. Specifically, the control unit of the first device blocks the output from the interface for executing the shared software to be transmitted to the display of the first device when the delete request signal is received. The interface for executing the shared software refers to particulars such as directories storing the shared software, files, a program menu for the execution, and the like which are needed to execute the shared software and displayed on the display. The blocking of the output from the interface means making the corresponding shared software appear to be deleted from the first device. Therefore, a user of the first device cannot see anything associated with the shared software and cannot execute the shared software. This also means that the shared software is deleted from the management screen and cannot be seen. For example, it means that icons used to execute the shared software or character formats including an execution instruction are deleted. Therefore, from the user's point of view, the shared software is completely deleted from the first device. However, the software is still stored in the first device.

In operation 530, the first device that receives the delete request signal transmits the received delete request signal to the shared software management device.

Accordingly, when there is a delete instruction from the user, the shared software appears deleted from the screen, so that a user environment can be improved. In addition, the shared software is deleted by the manager, so that the ill-considered deletion can be prevented. In addition, in terms of managing the software shared by the devices in the network, the shared software can be recovered instead of re-installing the software instructed to be deleted by the user's instruction.

The shared software management method can also be embodied as computer readable codes on a computer readable recording medium. The computer readable recording medium is any data storage device that can store data which can be thereafter read by a computer system. Examples of the computer readable recording medium include, but are not limited to, read-only memory (ROM), random-access memory (RAM), CD-ROMs, magnetic tapes, floppy disks, optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of managing a shared software, the method comprising:
receiving, from a first device, a request to delete a shared software used by a second device; and
in response to the receiving the request to delete the shared software, blocking an output from an interface for executing the shared software to be transmitted to a display of the first device.

2. The method of claim 1, further comprising:
in response to the receiving the request to delete the shared software, determining whether to delete the shared software by comparing a frequency of using the shared software with a reference frequency; and
selectively deleting the shared software according to the determining.

3. The method of claim 2, wherein the selectively deleting the shared software comprises deleting the shared software if the frequency of using the shared software is less than the reference frequency according to the determining.

4. The method of claim 3, further comprising transmitting a request to confirm deletion of the shared software to the first device that transmits the request to delete the shared software if the frequency of using the shared software is equal to or more than the reference frequency according to the determining.

5. The method of claim 4, further comprising selectively recovering the shared software if the first device receives the request to confirm the deletion of the shared software.

6. The method of claim 1, further comprising deleting the shared software if the request to delete the shared software is received from all devices which share the shared software.

7. The method of claim 1, further comprising:
checking a frequency of using the shared software by each device which shares the shared software; and
deleting the shared software when the frequency of using the shared software is less than a reference frequency.

8. A method of managing a shared software, the method comprising:
receiving, at a first device, a request to delete a shared software used by a second device; and
blocking an output from an interface for executing the shared software in response to receiving the request to delete the shared software.

9. The method of claim 8, further comprising transmitting the request to delete the shared software from the first device to a shared software management device.

10. An apparatus for managing a shared software, the apparatus comprising:
a communication unit which receives from a first device a request to delete a shared software used by a second device; and
a control unit which blocks an output from an interface for executing the shared software to be transmitted to a display of the first device, in response to receipt of the request to delete the shared software.

11. The apparatus of claim 10, further comprising a determination unit which determines whether to delete the shared software by comparing a frequency of using the shared software with a reference frequency, in response to receipt of the request to delete the shared software,
wherein the control unit selectively deletes the shared software according to the determination by the determination unit.

12. The apparatus of claim 11, wherein the control unit deletes the shared software if the frequency of using the shared software is less than the reference frequency according to the determination by the determination unit.

13. The apparatus of claim 12, wherein the control unit transmits a request to confirm deletion of the shared software to the first device which transmits the request to delete the shared software if the frequency of using the shared software is equal to or more than the reference frequency according to the determination.

14. The apparatus of claim 10, wherein the control unit deletes the shared software if the control unit receives the delete request signals from all devices sharing the shared software.

15. The apparatus for managing the shared software of claim 10,
wherein the determination unit checks a frequency of using the shared software by each of the devices which shares the shared software, and
wherein the control unit deletes the shared software if a frequency of using the shared software is less than a reference frequency according to the determination by the determination unit.

16. The apparatus for managing the shared software of claim 10, wherein the second device is at least one of a copy machine, a printer, and a multi-function printer.

17. An apparatus for managing a shared software, the apparatus comprising:
a communication unit which receives a request to delete a shared software used by a device; and
a control unit which blocks an output from an interface for executing the shared software in response to receipt of the request to delete the shared software.

18. The apparatus for managing the shared software of claim 17, wherein the communication unit transmits the request to delete the shared software to another shared software management device.
